(19) United States
(12) Patent Application Publication
(10) Pub. No.: US 2007/0209466 A1
(43) Pub. Date: Sep. 13, 2007

(54) GEAR SHIFT FORK FOR A GEARBOX WITH DISCRETE GEAR RATIOS

(75) Inventors: Marco Garabello, Orbassano (IT); Valter Pastorello, Orbassano (IT)

Correspondence Address: SUGHRUE MION, PLLC, 2100 PENNSYLVANIA AVENUE, N.W., SUITE 800, WASHINGTON, DC, 20037, US

(73) Assignee: CRF SOCIETA CONSORTILE PER AZIONI, Orbassano (IT)

(21) Appl. No.: 11/612,925

(22) Filed: Dec. 19, 2006

(30) Foreign Application Priority Data
Mar. 6, 2006 (EP) 06425148.1

(51) Int. Cl. F16H 63/32

(52) U.S. Cl. 74/473.37

(57) ABSTRACT

The gear fork comprises a support portion arranged to be guided along a stationary rod of the gearbox, a pair of prongs which extend from the support portion and form at their distal ends respective finger-like portions adapted to act on a sliding coupling sleeve of the gearbox, and an actuating nose by means of which a sliding movement along the stationary rod for the engagement of the desired gear can be imparted to the fork. The support portion and the prongs can be integrally formed by a single sheet metal body obtained by blanking and bending or formed as two separate sheet metal pieces, each obtained by blanking and bending. The support portion is shaped and arranged with respect to the prongs so as to allow two forks having identical bodies to be mounted on the same stationary rod so as to at least partially overlap in the sliding direction along the rod.

### BACKGROUND OF THE INVENTION

The present invention relates to a gear shift fork for a gearbox with discrete gear ratios for a motor vehicle.

More particularly, the invention relates to a gear shift fork comprising a support portion intended to be slidably mounted on a stationary rod, a pair of prongs which extend from the support portion and form ate their distal ends respective finger portions adapted to act on a sliding coupling sleeve of the gearbox, and an actuating nose by means of which the fork is caused to slide along the stationary rod for engaging the desired gear.

### SUMMARY OF THE INVENTION

It is the object of the invention to provide a gear shift fork for a motor-vehicle gearbox with discrete gear ratios which can be manufactured at low cost, which can be used for actuating all the sliding coupling sleeves of a manual gearbox as well as all the sliding coupling sleeves of the robotized version and of the double-clutch version which can be derived from the same manual gearbox, which allows to minimize the axial size of a set of two forks arranged on the same rod, which allows to meet the prescribed dimension and geometric tolerances without the need of special or high-precision operations, which ensures the required mechanical strength and surface hardness in the areas subject to stresses in operation, and which offers a wide flexibility of use.

This and other objects are fully achieved according to the invention by virtue of a gear shift fork for motor-vehicle gearbox with discrete gear ratios for a having the characteristics defined in independent claim 1.

Further advantageous characteristics of the invention are specified in the dependent claims.

### BRIEF DESCRIPTION OF THE DRAWINGS

The characteristics and the advantages of the invention will become apparent from the following detailed description, given purely by way of non-limiting example with reference to the appended drawings, in which:

FIG. 1 is a perspective view which shows a shift fork according to a first preferred embodiment of the invention;

FIG. 2 is a view similar to the one of FIG. 1, in which the fork is shown without actuating nose;

FIG. 3 is a perspective view which shows an example of arrangement of four shift forks of the type shown in FIG. 1, suitable for both a hand-operated gearbox and a robotized gearbox derived therefrom;

FIG. 4 is a perspective view which shows an example of arrangement of four shift forks of the type shown in FIG. 1, suitable for both a double-clutch gearbox and a robotized gearbox derived therefrom;

FIG. 5 is a perspective view which shows a shift fork according to a further preferred embodiment of the invention; and

FIG. 6 is a view similar to the one of FIG. 5, in which the fork is shown without actuating nose.

In the following description and claims the term “longitudinal” is used to indicate a direction parallel to the axis of the shafts of the gearbox, that is, a direction parallel to the stationary rods on which the gear shift forks are slidably mounted, whereas the term “transverse” is used to indicate any direction perpendicular to the above-mentioned longitudinal direction.

### DETAILED DESCRIPTION OF THE PREFERRED EMBODIMENTS

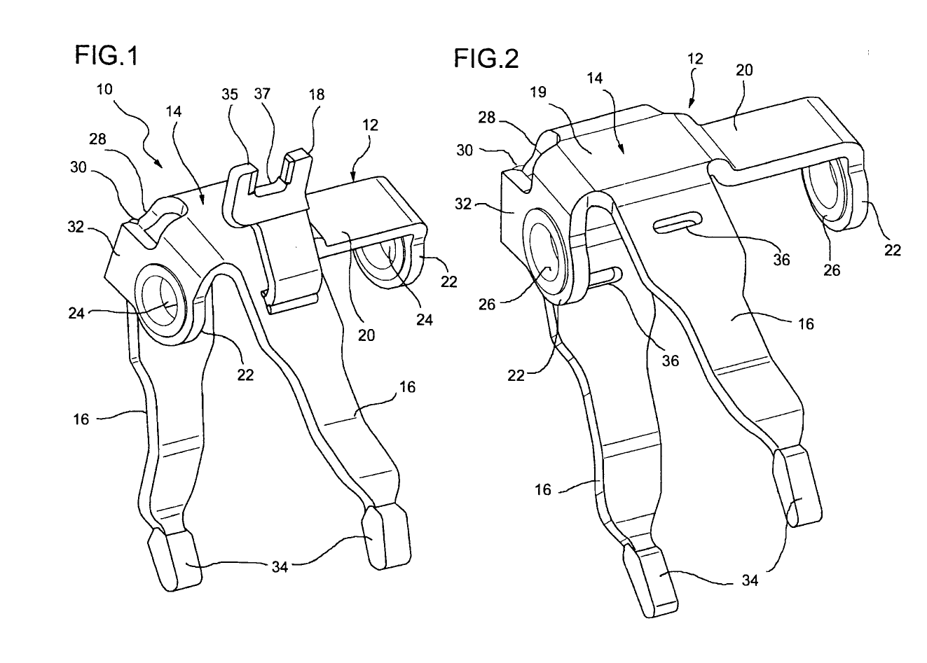

With reference first to FIGS. 1 and 2, a gear shift fork for a motor-vehicle gearbox with discrete gear ratios is generally indicated 10 and basically comprises a sheet-metal body 12, which according to a first preferred embodiment of the invention forms integrally a support portion 14 and a pair of prongs 16 projecting from opposite sides of the support portion 14, and an actuating nose 18 which is formed as a separate component from the sheet-metal body 12 and securely connected thereto.

The support portion 14 includes a central plate portion 19, which in the condition in which it is mounted on the respective stationary rod (not shown in FIGS. 1 and 2) lies in plane parallel to the axis of the rod and which preferably has a rectangular shape elongated in the longitudinal direction, and a pair of ears 22 which are arranged at right angles to the central plate portion 19. The ears 22 have respective coaxial holes 24 defining seats for guiding the sliding movement of the fork 10 along the rod. Preferably, as provided for in the embodiment shown in FIGS. 1 and 2, one of the two ears 22 is disposed at a greater distance from the prongs 16 than the other ear. In this connection, the support portion 14 also includes an appendage 20 which extends longitudinally from the central plate portion 19 and forms at its opposite end on eof the two ears 22. In other words, the support portion 14 is disposed in a non-symmetric position with respect to a plane of symmetry of the two prongs 16 perpendicular to the axis of the stationary rod. According to a variant of embodiment, not shown, also the other ear 22 could be formed at the end of a second appendage extending from the central plate portion on the opposite side to the first appendage 20.

The holes 24 formed in the ears 22 are advantageously provided with respective antifriction and wearproof bushes 26. The bushes 26 are preferably produced by plastics overmoulding so as to meet the required dimensional and geometric tolerances without the need of performing additional machining operations on the body 12.

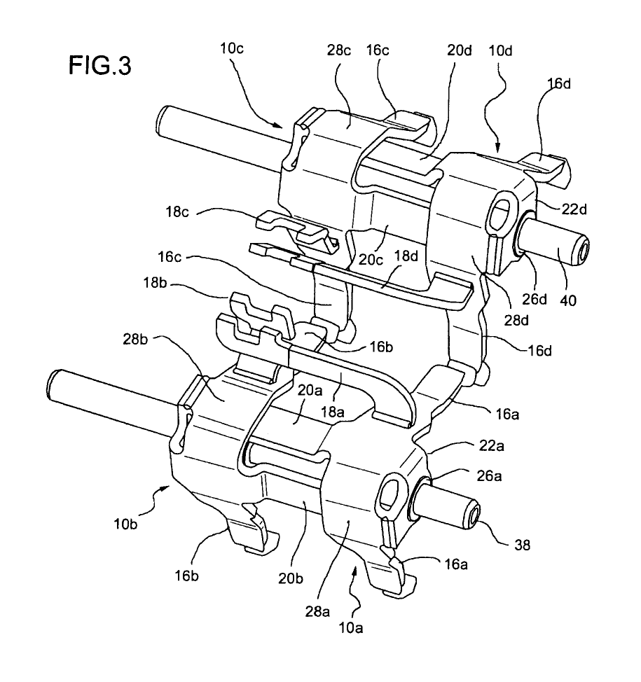

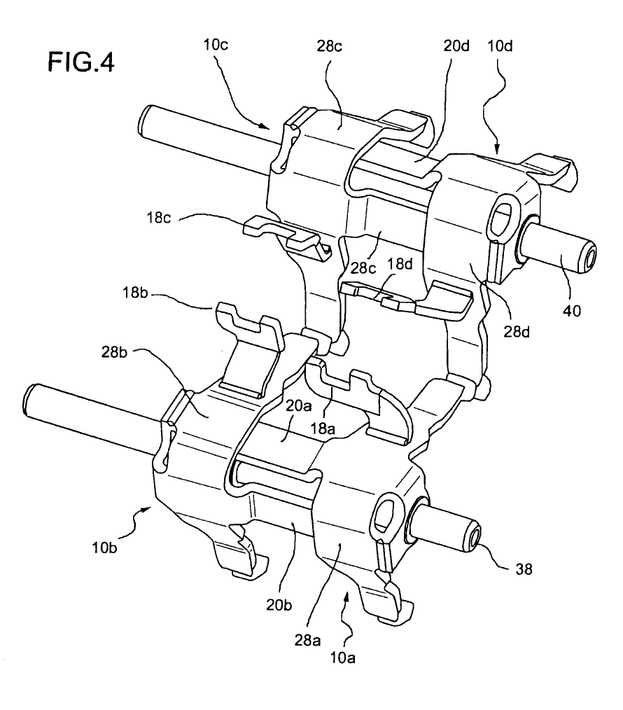

The prongs 16 extend transversely from the central plate portion 19, the one directly from one of the two longitudinal sides thereof and the other from a bridge-like portion 28 (which can be better seen in FIGS. 3 and 4) bent with respect to the central plate portion 19. In order to stiffen the support portion 14 of the body 12, the bridge-like portion 28 is welded by means of a weld bead 30 to a tab 32 extending laterally from one of the two ears 22.

The two prongs 16 are made as plate-like elongated elements, which extend in length on a transverse plane, that is, perpendicularly to the direction along which the fork slides, and in width along a parallel direction top the direction along which the fork slides, so as to have a high bending stiffness and hence to limit the deformations brought about by the actuation forces. The width of the prongs 16 reduces progressively from the proximal ends thereof (that is, from the ends facing the support portion 14) to distal ends thereof (that is, the ends opposite to the support portion 14). These latter have a finger-like configuration suitable for acting on a sliding coupling sleeve (not shown) arranged to engage either one or two gears. The finger-like ends of the prongs 16 are advantageously provided with an antifriction plastics coating 34, preferably made by overmoulding.

In their proximal portions, the prongs 16 have respective slots 36 (FIG. 2), one of which is used for the fitting of the actuating nose 18. The two slots 36 are formed in symmetric positions relative to the finger-like ends of the prongs 16, thereby allowing the actuating nose 18 to be fitted in either one of the slots depending on the orientation of the fork 10. Advantageously, the actuating nose 18 is provided with an antifriction plastics coating 35, made by overmoulding, in the nose portion surrounding a recess 37 intended for engaging a special control member (not shown), such as for example a finger-like member carried by the lever of the control shaft of the gearbox.

Due to its particular arrangement, the body of the body can be easily manufactured as a single piece by blanking and bending and can therefore be produced at a low cost.

Moreover, as will be better understood in view of the following part of the description, all the forks of the manual gearbox, as well as of the double-clutch gearbox or of the robotized gearbox derived therefrom, share the same body and differ from each other only in the actuating nose. This enables to further reduce the cost of the fork and make its manufacturing method easier.

Another advantage is given by the fact that the support portion is arranged asymmetrically relative to a plane of symmetry of the two prongs perpendicular to the axis of the stationary rod and is configured so as to enable a set of two partially overlapped forks to be mounted on the same stationary rod. In this way, even though a proper support on the stationary rod, that is, an adequate distance between the two support ears, is maintained, it is possible to greatly reduce the axial size of the set of two forks with respect of the side-to-side arrangement of the forks according to the prior art.

Referring now to FIGS. 3 and 4, two examples of arrangement of the shift forks for a manual gearbox and for a double-clutch gearbox, respectively, will be described.

FIG. 3 illustrates an example of arrangement of the shift forks which can be used both in a manual gearbox having six forward gears and one rearward gear and in the robotized gearbox derived therefrom. In the illustrated example four shift forks, indicated 10a, 10b, 10c and 10d, are provided, which are arranged in sets of two forks on a pair of stationary rods 38 and 40 parallel to the axes of the input shaft and of the outer shafts of the gearbox (not shown). More in detail, a first shift fork 10a for the first and second gears and a second shift fork 10b for the fifth and sixth gears are slidably arranged on the rod 38, whereas a third shift fork 10c for the third and fourth gears and a fourth shift fork 10d for the rear gear are slidably arranged on the rod 40. The parts and components associated to the four forks are indicated by the same reference numerals as those used in FIGS. 1 and 2, with the addition of the letter a, b, c or d depending on those parts or components belonging or being associated to the fork 10a, 10b, 10c or 10d, respectively.

As can be immediately noted, the bodies 12a-12d of the forks 10a-10d are identical to one another. The only difference between the various forks is given by the actuating noses 18a-18d. Since this arrangement is associated to a single-clutch gearbox, either manual or robotized, the actuating noses 18a-18d are arranged on a single transverse shift plane. Moreover, the forks are conveniently mounted in pairs on the same rod in a mirror-like manner, that is, with the prongs 16a-16d arranged on longitudinally opposite sides and with the appendages pointing to longitudinally facing sides. Furthermore, the prongs 16a, 16b and 16c, 16d of each pair of forks 10a, 10b and 10c, 10d, respectively, are arranged in the same side of the associated stationary rod 38 and 40, respectively. In this way, the first pair of forks 10a, 10b is arranged to act on a pair of coupling sleeves (not shown) disposed on a same output shaft (also not shown) of the gearbox. Likewise, the second pair of forks 10c, 10d is arranged to act on a pair of coupling sleeves (not shown) disposed on a same output shaft (also not shown) of the gearbox. Additionally, the appendage 20a-20d of a fork is arranged under the bridge-like portion 28a-28d of the other fork and can thus slide relative thereto. It is therefore possible to limit the axial size of the sets of forks without the need of reducing the distance between the guide seats on the rod. The invention thus provides an optimal compromise between the opposite requirements for limitation of the axial size and for resistance against the tipping and jamming of the forks during actuation.

FIG. 4 illustrates on the other hand an example of arrangement of the shift forks which can be used both in a double-clutch gearbox having six forward gears and one rearward gear and in a robotized gearbox derived therefrom. As in the example of FIG. 3, also in this case four shift forks 10a, 10b, 10c and 10d, arranged in sets of two forks on a pair of stationary rods 38 and 40, are provided. More in detail, a first fork 10a for the first and fifth gears and a second fork 10b for the sixth gear are slidably arranged on the rod 38, while a third fork 10c for the second and fourth gears and a fourth fork 10d for the third and rear gears are slidably arranged on the rod 40. Unlike the arrangement illustrated in FIG. 3, the actuating noses are arranged on two different transverse shift planes, namely on a first plane associated to the even gears (actuating noses 18b and 18c) and a second plane associated to the odd gears and to the rear gear (actuating noses 18a and 18d). In particular, only the noses of the second plane are different from those used in the manual gearbox, whereas those of the first plane remains identical to those used in the manual gearbox or in a possible robotized gearbox derived therefrom.

As far as the partially overlapping arrangement of the sets of two forks and the arrangement of the prongs with respect to the stationary rods are concerned, the same considerations apply as those exposed before with reference to FIG. 3.

It is however clear that the forks might also be arranged singularly, rather than in sets of two forks. Moreover, the forks might be all arranged, either singularly or in sets of two, on one stationary rod or on several stationary rods.

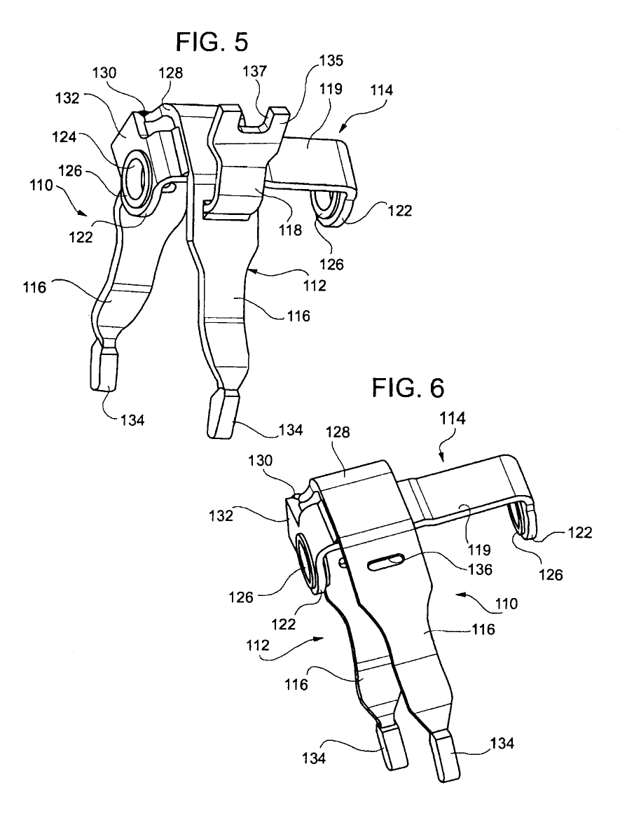

Finally, a further preferred embodiment of a shift fork according to the invention is shown in FIGS. 5 and 6, where parts and elements identical or corresponding to those of FIGS. 1 and 2 bear the same reference numerals, increased by 100.

With reference to FIGS. 5 and 6, a gear shift fork 110 for a motor-vehicle gearbox with discrete gear ratios differs from the first embodiment described above substantially only in that the body of the fork is made in this case in two separate pieces, instead of a single piece. The body of the shift fork 110, now indicated 112, comprises in fact a first sheet metal piece forming a support portion 114 and a second sheet metal piece forming a pair of prongs 116, firmly secured to one another, for example by welding. Moreover, the shift fork 110 comprises also in this case an actuating nose 118 (shown in FIG. 5 only) inserted and fixed in one of the two slots 136 symmetrically disposed relative to a finger-like end of the prongs 116.

The support portion 114 includes a central plate portion 119, having preferably a rectangular shape elongated in the longitudinal direction and laying, in the mounted condition on the respective stationary rod (not shown), in a plane parallel to the axis of the rod, and a pair of ears 122 arranged at a right angle to the central plate portion 119. The ears 122 have respective coaxial holes 124 defining guide seats for the sliding movement of the fork 110 along the rod.

A bridge-like portion 128, which is integrally formed by the second sheet metal piece and is welded by means of a welding bead 130 to a tab 132 extending laterally from one of the two ears 122 in order to stiffen the support portion 114 of the body 112, extends between the two prongs 116.

Also in this case one of the two ears 122 is arranged farther from the prongs 116 than the other ear, that is, the support portion 114 is not symmetrically arranged relative to a plane of symmetry of the prongs 116 perpendicular to the axis of the stationary rod. It is therefore possible to mount on the same stationary rod a set of two forks arranged so as to partially overlap, as shown in FIGS. 3 and 4.

As far as the provision of overmoulded antifriction bushes in the holes 124 of the ears 122, the configuration of the prongs 116 and the provision of an overmoulded antifriction coating on the actuating nose 118, the same considerations as those exposed above with reference to the first embodiment illustrated in FIGS. 1 and 2 apply.

Clearly, also this second embodiment offers all the advantages listed above in connection with the first embodiment. Moreover, since the support portion and the prongs are formed by two separate sheet metal pieces, which are obtained preferably by blanking and are then secured to each other, it is possible to properly vary both the material and the thickness of the two pieces so as to optimize the mass, the size and the mechanical strength of the shift fork. Moreover, the scrap produced during the blanking operation is greatly reduced in comparison with the single-piece configuration of the fork body.

Naturally, the principle of the invention remaining unchanged, the embodiments and the details of construction could widely vary from those described and illustrated purely by way of non-limiting example.

For example, the idea of providing overmoulded plastics bushes in the guide holes could be applied also to a fork having a conventional body, not formed as a single sheet metal piece produced by blanking and bending.

What is claimed is:

1. A gear shift fork for a gearbox with discrete gear ratios, comprising
a body including a support portion arranged to be guided along a stationary rod of the gearbox and a pair of prongs which extend on opposite sides of the support portion and form at their distal ends respective finger-like portions adapted to act on a sliding coupling sleeve of the gearbox, and
an actuating nose fixed to the body, by means of which a sliding movement along the stationary rod for the engagement of the desired gear can be imparted to the fork;
characterized in that the support portion is shaped and arranged with respect to the prongs so as to allow two forks having identical bodies to be mounted on the same stationary rod so as to at least partially overlap in the sliding direction along said rod.

2. Gear fork according to claim 1, wherein the two prongs have a plane of symmetry perpendicular to the stationary rod and the support portion is non-symmetrically arranged relative to said plane of symmetry.

3. Gear fork according to claim 1, wherein the prongs are formed as plate-like elongated elements, which extend in length perpendicular to the sliding direction of the fork along the stationary rod and in width parallel to said sliding direction.

4. Gear fork according to claim 1, wherein the support portion includes a central plate portion extending in the sliding direction of the fork along the stationary rod and a pair of ears arranged at a right angle to the central plate portion on the opposite sides thereof, the ears having respective coaxial guide holes adapted to guide the sliding movement of the fork along the stationary rod.

5. Gear fork according to claim 4, wherein one of the ears is arranged farther from the prongs than the other ear.

6. Gear fork according to claim 1, wherein the body has a pair of slots for the mounting of the actuating nose, arranged symmetrically relative to the finger-like ends of the prongs.

7. Gear fork according to claim 6, wherein the slots are formed in the prongs.

8. Gear fork according to claim 4, further comprising a pair of plastics bushes, each fitted in a respective guide hole.

9. Gear fork according to claim 1, wherein the finger-like ends of the prongs are provided with an antifriction plastics coating.

10. Gear fork according to claim 8, wherein the bushes and/or the antifriction coatings of the finger-like ends of the prongs are obtained by plastics overmoulding.

11. Gear fork according to claim 1, wherein the actuating nose has a recess for engaging a control member and is provided with an antifriction plastics coating around said recess.

12. Gear fork according to claim 11, wherein the antifriction plastics coating around the recess of the actuating nose is obtained by overmoulding.

13. Gear fork according to claim 1, wherein the support portion and the prongs are integrally formed by a single sheet metal body obtained by blanking and bending.

14. Gear fork according to claim 13, wherein the support portion includes a central plate portion extending in the sliding direction of the fork along the stationary rod and a pair of ears arranged at a right angle to the central plate portion on the opposite sides thereof, the ears having respective coaxial guide holes adapted to guide the sliding movement of the fork along the stationary rod, and an appendage extending from the central plate portion in the sliding direction of the fork, and wherein one of the ears is formed at an end of said appendage.

15. Gear fork according to claim 13, wherein the support portion further includes a bridge-like portion interposed between the central plate portion and one of the prongs.

16. Gear fork according to claim 15, wherein the bridge-like portion is welded to a tab extending laterally from one of the two ears, so as to stiffen the support portion.

17. Gear fork according to claim 14, wherein the support portion further includes a bridge-like portion interposed between the central plate portion and one of the prongs and wherein the appendage and the bridge-like portion of the support portion are shaped so as to allow two forks having an identical body to be mounted on the same stationary rod with the appendage of one of them being arranged under or over the bridge-like portion of the other.

18. Gear fork according to claim 14, wherein the bridge-like portion is welded to a tab extending laterally from one of the two ears, so as to stiffen the support portion, and wherein the appendage and the bridge-like portion of the support portion are shaped so as to allow two forks having an identical body to be mounted on the same stationary rod with the appendage of one of them being arranged under or over the bridge-like portion of the other.

19. Gear fork according to claim 1, wherein the support portion is formed by a first sheet metal piece obtained by blanking and bending and the prongs are formed by a second sheet metal piece obtained by blanking and bending, the two sheet metal pieces being firmly secured to each other.

20. Gear fork according to claim 19, wherein said second piece includes a bridge-like portion interposed between the two prongs and wherein the support portion is shaped so as to allow two forks having an identical body to be mounted on the same stationary rod with a length of the central plate portion of a fork passing under or over the bridge-like portion of the other fork.

21. Gear fork according to claim 19, wherein the bridge-like portion is welded to a tab extending laterally from on of the two ears, so as to stiffen the support portion.
